(19) United States
(12) Patent Application Publication
(10) Pub. No.: US 2025/0380666 A1
(43) Pub. Date: Dec. 18, 2025

(54) Spherical Mesh Enclosure for Pets

(71) Applicant: John Joseph O'Connell, Fox River Grove, IL (US)

(72) Inventor: John Joseph O'Connell, Fox River Grove, IL (US)

(21) Appl. No.: 18/743,096

(22) Filed: Jun. 13, 2024

(51) Int. Cl. A01K 15/02

(52) U.S. Cl. CPC A01K 15/02

(57) ABSTRACT

An enclosure for pets that is spherical in shape with a plurality of concentric rings acting as the frame. The walls of the enclosure are made of mesh panels that span the space between the rings and are interfaced with said rings via channels. Pair of zippers on opposite sides of enclosure, when fastened, joins the interfaced rings and mesh panels to erect the enclosure in a spherical shape and contains the pet within. The spherical shape of the enclosure allows mobility to the animal within a space by means of rolling the enclosure when force is applied on the inner walls of the enclosure. When the pair of zippers are unfastened, the plurality of rings are free to rotate concentrically to allow enclosure to be flattened and circular in shape. The flattened enclosure can then be folded upon itself to form a smaller flattened circular shape.

### CROSS-REFERENCE TO RELATED APPLICATION

This application is based on, and claims priority to, U.S. Provisional Patent Application No. 63/628,074 filed on Jun. 17, 2023, contents of which are incorporated herein by reference.

### BACKGROUND OF THE INVENTION

### Field of the Invention

The present invention relates to an enclosure for the containment of a pet and in particular an enclosure that is spherical in shape to allow mobility of the contained pet within a space while providing protection from other animals and reducing the likelihood of escape from a space. It is advantageous for such an enclosure to be able to be disassembled or reconfigured to make for easy transportation and storage.

### SUMMARY OF THE INVENTION

It is an object of the present invention to provide a means to allow an animal, preferably a domesticated animal or pet, to be outdoors or in a space, where there would be otherwise concern for the protection of the pet or fear of the pet escaping, by containing the pet in a mesh enclosure that is spherical in shape that allows the pet mobility within a space and hinders the likelihood of escape by making it difficult for the pet to run at its full speed and by the size of the enclosure preventing the pet from fitting through narrow passages or pathways. While the pet is contained within the enclosure, the pet can simultaneously be mobile within a space by rolling the enclosure as it steps on the inner surfaces. This mobility allows the pet to explore its surroundings and not be restricted to a fixed location or area.

The enclosure in its erected state is spherical in shape, the framing of which comprises flexible concentric rings. The rings are comprised of flexible strips of material, the ends of which are housed in tube-like connectors which give the rings their circular shape. The orientation of the concentric rings is maintained by a plurality of fabric strips which are interfaced along the edges of mesh panels that span the space between the rings, forming channels that contain said rings. Channels across the midsection of the mesh panels contain a ring that is perpendicular and concentric to the other rings when the enclosure is in the erected state. The nature of the fabric of the mesh panels is to resist ripping or tearing from the environment within a space, such as vegetation, as well as the teeth or claws of the pet contained within the enclosure. The mesh openings are of the size to provide visibility to the pet of the space that the enclosure is within as well as adequate air to breath while contained within the enclosure, but small enough to prevent an appendage of the pet from passing through. Two zippers on opposite hemispheres of the enclosure, when fastened, contain the pet within the enclosure and erect the enclosure to a spherical shape. Unfastening the zippers allows for insertion and removal of the pet from the enclosure as well as allowing the plurality of rings to rotate concentrically to allow the enclosure to be a nearly flat circular shape. When the enclosure is a nearly flat circular shape it can then be folded upon itself to form a smaller, nearly flat circular shape.

### BRIEF DESCRIPTION OF DRAWINGS

FIG. 1 is a perspective view of the enclosure in the erected state.

FIG. 2 is a perspective view of the enclosure with zippers unfastened and rings oriented along the edges of the mesh panels are free to rotate concentrically.

FIG. 3 is a perspective view of the enclosure showing the rings oriented along the edges of the mesh panels nearly in the same plane and the orientation of the ring across the midsection of the mesh panels is unchanged.

FIG. 4 is a perspective view of the enclosure with the ring across the midsection of the mesh panels rotated concentrically to a similar orientation as the rings orientated along the edges of the mesh panels and the enclosure is in a nearly flat circular shape.

FIG. 5 is a perspective view of the enclosure being folded from the nearly flat circular shape to a smaller nearly flat circular shape.

FIG. 6 is a perspective view of a singular ring of the enclosure frame.

### DETAILED DESCRIPTION OF THE INVENTION

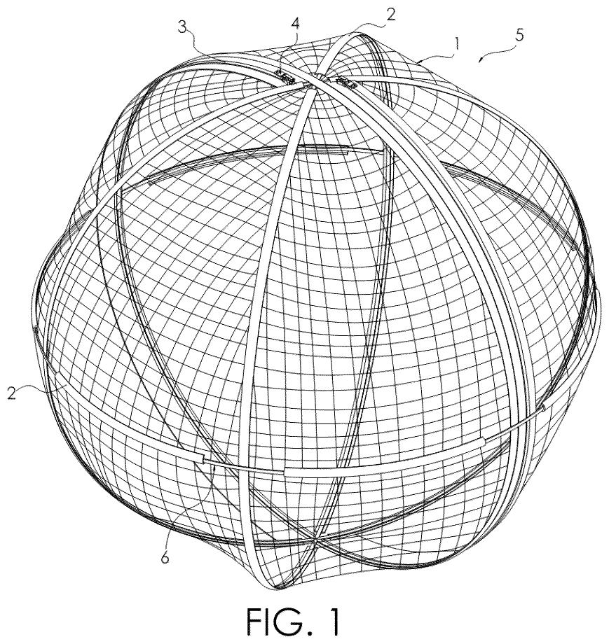

In the following detailed description, a preferred embodiment according to the present invention will be described with reference to FIG. 1 through FIG. 6.

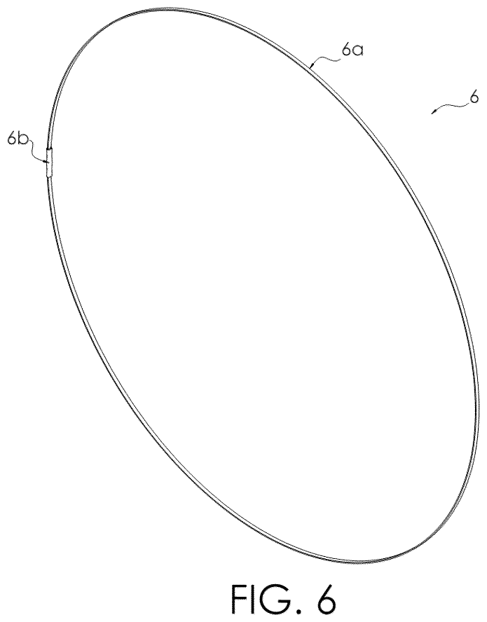

A first embodiment of an enclosure 5 is illustrated in FIG. 1. Zippers 3 containing a zipper-pull 4 are fastened and the enclosure 5 is in an erect state and is spherical in shape. While the enclosure 5 is in an erect state, an animal, preferably a domesticated animal or pet, may be contained within the enclosure 5 and the pet can simultaneously be mobile within a space by rolling the enclosure 5 as it steps on the inner surfaces. This mobility allows the pet to explore its surroundings and not be restricted to a fixed location or area. The enclosure 5 provides the contained animal a degree of protection from animals outside of said enclosure 5. The zippers 3 are on opposite hemispheres of the enclosure 5 and are interfaced along one edge of adjacent mesh panels 1. A plurality of mesh panels 1 span the spaces between the frame of the enclosure 5, which comprises a plurality of concentric rings 6. The rings 6 comprising a flexible strip of material 6a, the ends of which are housed in a tube-like connector 6b as shown in FIG. 6. The mesh panels 1 are interfaced with adjacent mesh panels 1 along an edge and are interfaced with strips of fabric along said edge, which form channels 2 in which the rings 6 are contained and concentrically constrained. Channels 2 are interfaced across the mid-section of mesh panels 1 and contain a ring 6 across said mid-section which is perpendicular and concentric to the rings 6 that are oriented along edges of mesh panels 1.

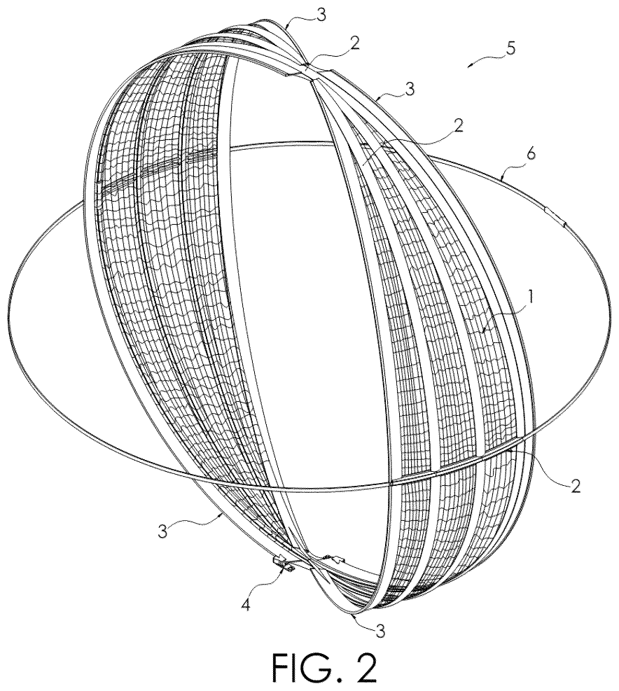

A second embodiment of the enclosure 5 is illustrated in FIG. 2. The zippers 3 and zipper-pulls 4 are in an unfastened state and allow the rings 6 that are orientated along the edges of mesh panels 1 to rotate concentrically in which the enclosure 5 is in an opened state. The channels 2 across the mid-sections of mesh panels 1 pass around the contained ring 6 across said mid-section.

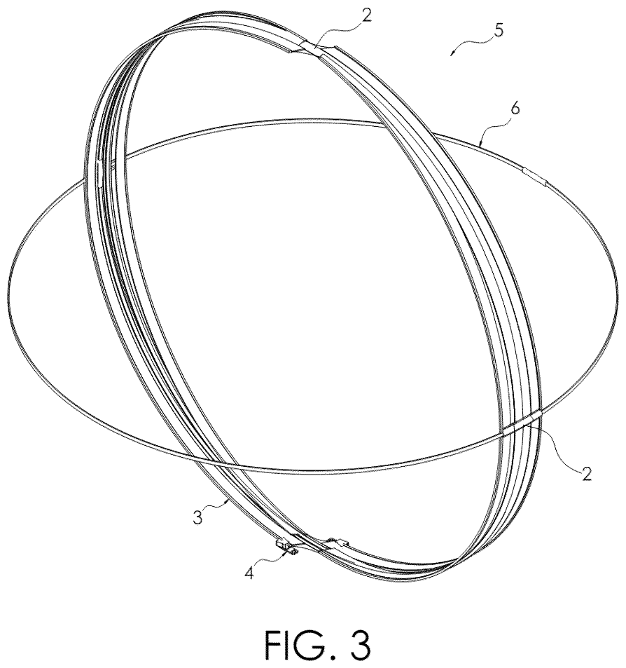

A third embodiment of the enclosure 5 is illustrated in FIG. 3. The rings 6 that are orientated along the edges of mesh panels 1 are nearly on the same plane. The channels 2 that contain the ring 6 across the mid-section of mesh panels 1 are compressed and said ring 6 is free to rotate concentrically about the enclosure 5.

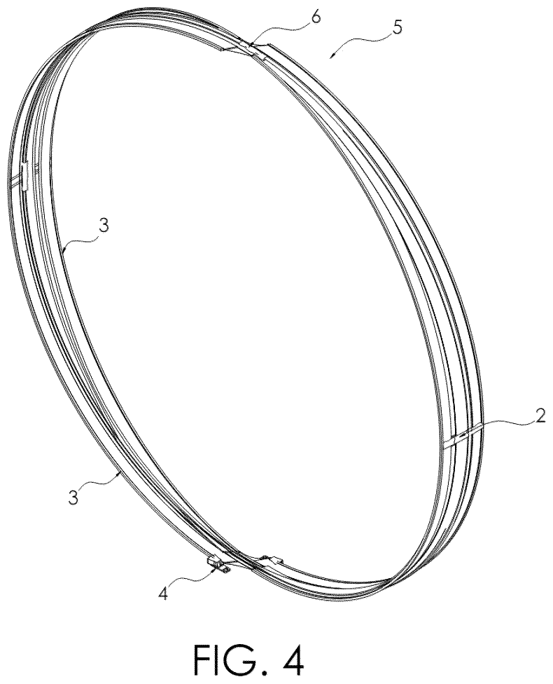

A fourth embodiment of the enclosure 5 is illustrated in FIG. 4. The ring 6 across the mid-section of mesh panels 1 has been rotated concentrically about the enclosure 5 and is nearly on the same plane as rings 6 that are orientated along edges of mesh panels 1. The enclosure 5 is of a nearly flat circular shape.

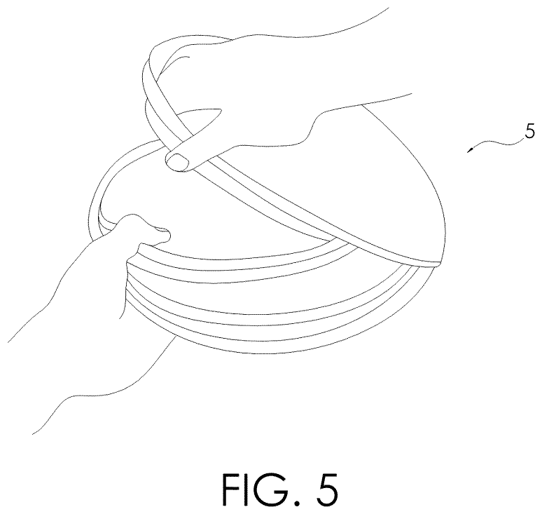

A fifth embodiment of the enclosure 5 is illustrated in FIG. 5. The enclosure 5 is in the process of being folded upon itself from a nearly flat circular shape as shown in FIG. 4. The rings 6 being oriented in a nearly flat circular shape, as shown in FIG. 4, allows for the enclosure 5 to be folded by means of twisting and bending the rings 6. When the operation of folding is complete, the enclosure 5 will be in a configuration of a smaller nearly flat circular shape.

An embodiment of rings 6 is illustrated in FIG. 6. The ring 6 comprises a flexible strip of material 6a, the ends of which are housed in a tube-like connector 6b. The mechanical characteristics of the flexible strip of material 6a are such that the plurality of rings 6 that act as the framing for the enclosure 5 can maintain a spherical shape in the erected state and are resistant to permanent deformation. The mechanical characteristics of the flexible strip of material 6a and profile are such to allow the enclosure 5 to be folded as shown in FIG. 5. The tube-like connector 6b houses the ends of the flexible strip of material 6a by means of friction, forming, fasteners or other methods of mechanically interfacing materials.

### DESCRIPTION OF SYMBOLS

1: mesh panel
2: channels
3: zipper
4: zipper-pull
5: enclosure
6: ring
6a: flexible strip of material
6b: tube-like connector

1. An enclosure comprising:
a frame structure comprising plurality of concentric rings;
a plurality of mesh panels that span the space between said rings;
a plurality of channels interfaced with said mesh panels which contains and concentrically constrains said rings; and
a plurality of zippers interfaced with said mesh panels.

2. An enclosure as in claim 1, wherein said enclosure is erected and spherical in shape when zippers are fastened.

3. An erected spherical enclosure as in claim 2 that permits animal containment and mobility.

4. An erected spherical enclosure as in claim 3 wherein animal movement while contained in the enclosure affects enclosure mobility.

5. An enclosure as in claim 1, wherein said zippers span opposite hemispheres of said enclosure and are interfaced along an edge of a mesh panel.

6. An enclosure as in claim 5, wherein said zippers contain zipper-pulls that are self-locking.

7. An enclosure as in claim 1, wherein the plurality of mesh panels are interfaced along the edges of adjacent mesh panels.

8. An enclosure as in claim 7, wherein said mesh panels are the same shape.

9. An enclosure as in claim 1, wherein said channels are oriented along and interfaced with edges of said mesh panels.

10. An enclosure as in claim 1, wherein said channels are oriented across midsection of said mesh panels.

11. An enclosure as in claim 1, wherein said rings comprise a flexible strip of material and a tube-like connector.

12. An enclosure as in claim 11, wherein said flexible strip of material permits said enclosure to maintain a spherical shape when erect and resists permanent deformation.

13. An enclosure as in claim 11, wherein said tube-like connector houses ends of said flexible strip of material by means of friction, forming, fastening, or other means of mechanical assembly.

14. A method of collapsing an enclosure that is spherical in shape when erected, comprising:
a frame structure comprising plurality of concentric rings;
a plurality of mesh panels that span the space between said rings;
a plurality of channels interfaced with said mesh panels which contains and concentrically constrains said rings; and
a plurality of zippers interfaced with said mesh panels,
wherein the method of collapsing the enclosure comprises:
unfastening the zippers on each hemisphere of the enclosure;
rotating the rings oriented along edges of said mesh panels concentrically to a configuration in which said rings are nearly on the same plane;
rotating the ring oriented across the midsection of said mesh panels concentrically so that it is nearly on the same plane as the rings oriented along edges of the mesh panels and the enclosure is in a nearly flat circular shape; and
folding the enclosure to a smaller and nearly flat circular shape.

15. The method of claim 14 where the enclosure is erected when the zippers are fastened and permits simultaneous animal containment and mobility.

16. The method of claim 15 wherein animal movement affects enclosure mobility.

17. A method of containing an animal, comprising:
forming an enclosure that is spherical when erected comprising a frame structure and a plurality of concentric rings;
forming a plurality of mesh panels that span the space between said rings;
forming a plurality of channels interfaced with said mesh panels which contains and concentrically constrains said rings;
forming a plurality of zippers interfaced with said mesh panels, wherein fastening the said zippers permits the spherical enclosure to be erected;
forming inner surfaces on the said mesh panels; and
wherein the erected spherical enclosure permits simultaneous animal containment and mobility.

18. The method of claim 17 wherein the mobility results when the animal steps on the inner surfaces of the said mesh panels.

19. The method of claim 17 wherein the spherical enclosure provides the contained animal a degree of protection from animals outside of said enclosure.

20. The method of claim 17 wherein the spherical enclosure reduces the contained animal's likelihood of escape from a space by preventing said animal from fitting through narrow passages.
